(19) United States
(12) Patent Application Publication
(10) Pub. No.: US 2012/0089407 A1
(43) Pub. Date: Apr. 12, 2012

(54) SYSTEM AND METHOD FOR FILTERING TRIP ITINERARIES

(76) Inventors: Adam Julian Goldstein, San Francisco, CA (US); Steven Ladd Huffman, San Francisco, CA (US)

(21) Appl. No.: 13/152,147

(22) Filed: Jun. 2, 2011

Related U.S. Application Data
(60) Provisional application No. 61/477,488, filed on Apr. 20, 2011.
(60) Provisional application No. 61/477,495, filed on Apr. 20, 2011.
(60) Provisional application No. 61/391,997, filed on Oct. 11, 2010.

(51) Int. Cl. G06Q 10/00

(52) U.S. Cl. 705/1.1

(57) ABSTRACT

A system, a computer-readable storage medium including instructions, and a computer-implemented method for filtering trip itineraries is described. Trip itineraries are received. A position of a first time slider on a time axis of a time graph displayed in a user interface of a computer system is determined, wherein the first time slider is configured to be moved across the time axis of the time graph. A first set of the trip itineraries is identified based on the position of the first time slider on the time axis. Graphical representations of the first set of the trip itineraries are displayed on the time graph, wherein a graphical representation of a trip itinerary indicates a departure time and duration of the trip itinerary.

### RELATED APPLICATIONS

This application claims priority under 35 U.S.C §119 to U.S. Provisional Patent Application No. 61/477,488 filed 20 Apr. 2011, entitled “System and Method for Grouping Trip Itineraries,” by inventors Steven Ladd Huffman and Adam Julian Goldstein; this application also claims priority under 35 U.S.C §119 to U.S. Provisional Patent Application No. 61/477,495 filed 20 Apr. 2011, entitled “System and Method for Filtering Trip Itineraries”, by inventors Adam Julian Goldstein and Steven Ladd Huffman; this application also claims priority under 35 U.S.C. §119 to U.S. Provisional Patent Application No. 61/391,997 filed 11 Oct. 2010, entitled “System and Method for Identifying Flight Itineraries,” by inventors Adam Julian Goldstein and Steven Ladd Huffman; this application also claims priority under 35 U.S.C. §120 to U.S. Design patent application Ser. No. 29/383,565 filed 19 Jan. 2011, entitled “User Interface for a Display,” by inventors Adam Julian Goldstein and Steven Ladd Huffman; this application also claims priority under 35 U.S.C. §120 to U.S. Design patent application Ser. No. 29/383,568 filed 19 Jan. 2011, entitled “Transitional User Interface for a Display,” by inventors Adam Julian Goldstein and Steven Ladd Huffman; this application also claims priority under 35 U.S.C. §120 to U.S. Design patent application Ser. No. 29/383,570 filed 19 Jan. 2011, entitled “User Interface for a Display,” by inventors Adam Julian Goldstein and Steven Ladd Huffman; this application also claims priority under 35 U.S.C. §120 to U.S. Design patent application Ser. No. 29/383,574 filed 19 Jan. 2011, entitled “Transitional User Interface for a Display,” by inventors Adam Julian Goldstein and Steven Ladd Huffman; this application also claims priority under 35 U.S.C. §120 to U.S. Design patent application Ser. No. 29/383,575 filed 19 Jan. 2011, entitled “Transitional User Interface for a Display,” by inventors Adam Julian Goldstein and Steven Ladd Huffman; this application also claims priority under 35 U.S.C. §120 to U.S. Design patent application Ser. No. 29/383,576 filed 19 Jan. 2011, entitled “Transitional User Interface for a Display,” by inventors Adam Julian Goldstein and Steven Ladd Huffman; this application also claims priority under 35 U.S.C. §120 to U.S. Design patent application Ser. No. 29/383,578 filed 19 Jan. 2011, entitled “Transitional User Interface for a Display,” by inventors Adam Julian Goldstein and Steven Ladd Huffman; this application also claims priority under 35 U.S.C. §120 to U.S. Design patent application Ser. No. 29/383,579 filed 19 Jan. 2011, entitled “Transitional User Interface for a Display,” by inventors Adam Julian Goldstein and Steven Ladd Huffman; which applications are incorporated by reference herein in their entirety.

### TECHNICAL FIELD

The disclosed embodiments relate generally to a system and method for filtering trip itineraries.

### BACKGROUND

Travel websites provide tools for travelers to search for and display trip itineraries (e.g., transportation and lodging options). These tools typically allow travelers to filter out trip itineraries based on various constraints (e.g., departure city, arrival city, date, time, cabin class). For example, a traveler searching for flights between San Francisco International Airport (SFO) and John F. Kennedy Airport (JFK) may desire to exclude flights that leave SFO before 6 AM and after 10 PM. Unfortunately, these tools do not provide an intuitive mechanism for filtering out trip itineraries.

### BRIEF DESCRIPTION OF THE DRAWINGS

The embodiments disclosed in the present disclosure are illustrated by way of example, and not by way of limitation, in the figures of the accompanying drawings. Like reference numerals refer to corresponding parts throughout the drawings.

FIG. 1 is a block diagram illustrating a networked system, according to some embodiments.

FIG. 2 is a block diagram illustrating a server, according to some embodiments.

FIG. 3 is a block diagram illustrating a client computer system, according to some embodiments.

FIG. 4 is a block diagram illustrating an aggregator computer system, according to some embodiments.

FIG. 5 is a block diagram illustrating a server-side trip itinerary data structure, according to some embodiments.

FIG. 6 is a block diagram illustrating a server-side routing data structure, according to some embodiments.

FIG. 7 is a block diagram illustrating a server-side leg data structure, according to some embodiments.

FIG. 8 is a block diagram illustrating a search data structure, according to some embodiments.

FIG. 9 is a block diagram illustrating a client-side routing data structure, according to some embodiments.

FIG. 10 is a block diagram illustrating a client-side trip itinerary data structure, according to some embodiments.

FIG. 11 is a block diagram illustrating a client-side routing time data structure, according to some embodiments.

FIG. 12 is a flowchart of a method for filtering trip itineraries, according to some embodiments.

FIG. 13 is a flowchart of a method for updating displayed trip itineraries, according to some embodiments.

FIG. 14 is a flowchart of a method for using two time sliders to update displayed trip itineraries, according to some embodiments.

FIG. 15 is a screenshot of an exemplary user interface for filtering trip itineraries, according to some embodiments.

FIG. 16 is a screenshot of the exemplary user interface for filtering trip itineraries after a departure time slider has been moved to a new position, according to some embodiments.

FIG. 17 is a screenshot of the exemplary user interface for filtering trip itineraries after an arrival time slider has been moved to a new position, according to some embodiments.

FIG. 18 is a screenshot of the exemplary user interface for filtering trip itineraries after a departure time slider and an arrival time slider have been moved to new positions, according to some embodiments.

FIG. 19 is a block diagram of a machine, according to some embodiments.

FIG. 20 illustrates a drop-down box usable to select times, according to some embodiments.

FIGS. 21A and 21B illustrate sliders usable to select times, according to some embodiments.

### DESCRIPTION OF EMBODIMENTS

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures and techniques have not been shown in detail.

Note that the term “trip itinerary” is used in this specification to refer to one or more routes to one or more destinations that are associated with particular dates and/or times. A route may be traversed by an airplane, a train, a bus, a car, or any other mode of transportation. A destination may include a hotel, a restaurant, a point-of-interest (e.g., museum, landmark), or any other place to which a traveler may desire to travel. A route may include one or more legs between intermediate destinations. For example, a trip itinerary may include two routes: (1) a route from point A to point B and (2) a route from point B to point A (e.g., a round-trip trip itinerary). Route (1) may include two legs: (a) a leg from point A to point C and (2) a leg from point C to point B. Route (2) may include one leg from point B to point A.

Also note that although the following description refers to flights, the embodiments described herein may be applied to any mode of transportation including, but not limited to, airplane, train, bus, car, bicycle, foot, and the like. Furthermore, the embodiments described herein may be applied to displaying itineraries for hotel reservations, car rentals, restaurant reservations, and any type of reservation that involves a time and/or a date.

As discussed above, search tools on existing travel websites do not provide intuitive mechanisms for filtering out trip itineraries.

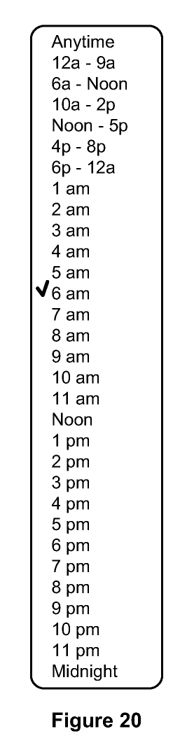

One mechanism is a drop-down box that includes a number of times and/or time intervals from which the user selects at least one time to limit search results, as illustrated in FIG. 20. Unfortunately, these drop-down boxes leave ambiguity as to how the trip itineraries are actually filtered. For example, if a traveler selects “6 am” as a departure time, (as illustrated in FIG. 20) it is ambiguous as to whether trip itineraries are limited to (1) trip itineraries whose departure times are within a predetermined time of 6 AM (e.g., +/−1 hour of 6 AM), (2) the N trip itineraries whose departure times are closest to 6 AM, or (3) the trip itineraries whose departure times are on or after 6 AM.

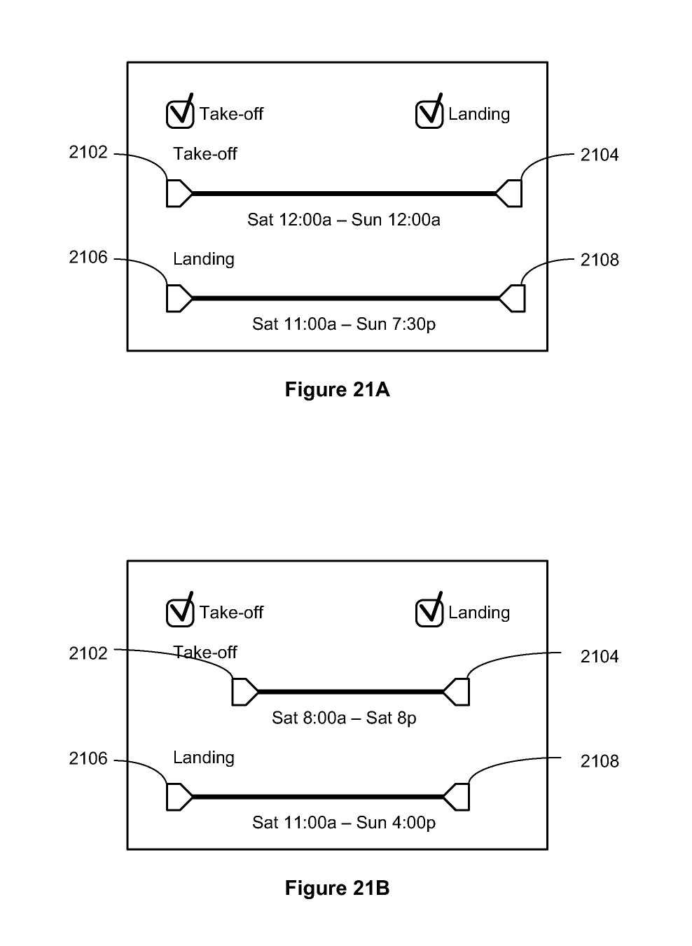

Another mechanism is a slider that can be moved across a line (a curve, an object) to select a time. FIGS. 21A and 21B illustrate departure time sliders 2102 and 2104 and arrival time sliders 2106 and 2108. In FIG. 21A, the departure time sliders 2102 and 2104 and the arrival time sliders 2106 and 2108 are set so that only trip itineraries that depart between 12 AM on Saturday and 12 AM on Sunday and that arrive between 11AM on Saturday and 7:30 PM on Sunday are included in the search results. In FIG. 21B, the departure time sliders 2102 and 2104 and the arrival time sliders 2106 and 2108 are set so that only trip itineraries that depart between 8 AM on Saturday and 8 PM on Saturday and that arrive between 11 AM on Saturday and 4 PM on Sunday are included in the search results.

Drop-down boxes and/or time sliders are typically displayed separately from the trip itineraries. For example, travel websites typically display drop-down boxes and/or time sliders at the edges of a browser window and separately from the trip itineraries. Since the drop-down boxes and the time sliders are displayed separately from the trip itineraries, it is often not clear how the selection of the time and/or time intervals affects the results. For example, if a user selects 6 AM as a departure time, a traveler does not have intuition as to which trip itineraries will be filtered out prior to making the selection, but instead, only knows which trip itineraries are filtered out after making the selection. This disconnected display of the search tool and the trip itineraries often causes a traveler to experiment with time selections until the desired trip itineraries are identified.

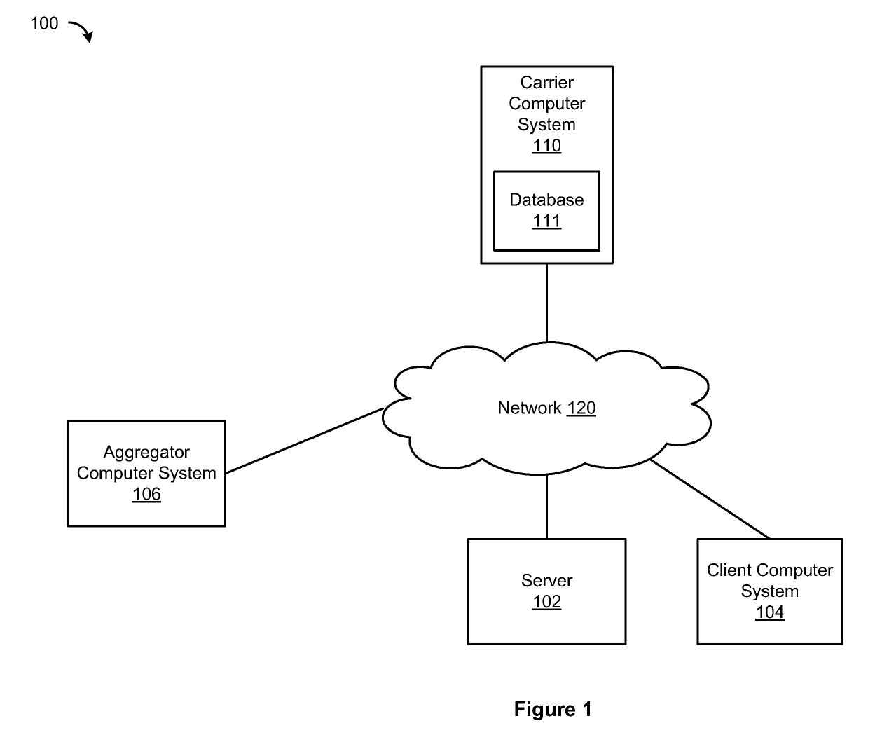

FIG. 1 is a block diagram illustrating a networked system 100, according to some embodiments. The networked system 100 includes a server 102, a client computer system 104 (e.g., a computer system of a traveler), an aggregator computer system 106, and a carrier computer system 110. Note that although only one computer system is illustrated for each of the server 102, the client computer system 104, the aggregator computer system 106, and the carrier computer system 110, the embodiments described herein may be applied to multiple instances of these computer systems. For example, the server 102 may include a plurality of distributed servers (e.g., geographically distributed servers, distributed servers within a data center) where each server handles a portion of the computations (e.g., search requests). Similarly, the aggregator computer system 106 may be one of a plurality of distributed computer systems operated by a single aggregator (e.g., an entity that sells aggregated trip itineraries) and the carrier computer system 110 may be one of a plurality of distributed computer systems operated by a single carrier (e.g., a single airline, an airline alliance). Moreover, multiple aggregators and/or carriers may also operate in the networked system 100. Furthermore, the client computer system 104 may be one of a plurality of client computer systems, each of which is operated by a traveler. Note that although the server 102, the aggregator computer system 106, and the carrier computer system 110 are illustrated as separate computer systems, two or more of the server 102, the aggregator computer system 106, and the carrier computer system 110 may be combined together into a single computer system. For example, the server 102 and the aggregator computer system 110 may be a single computer system.

In some embodiments, the server 102, the client computer system 104, the aggregator computer system 106, and the carrier computer system 110 are coupled to each other via network 120. Network 120 can generally include any type of wired or wireless communication channel capable of coupling together computing nodes (e.g., the server 102, the client computer system 104, the carrier computer system 110). This includes, but is not limited to, a local area network (LAN), a wide area network (WAN), or a combination of networks. In some embodiments, network 120 includes the Internet. In some embodiments, network 120 includes at least one private network (e.g., a virtual private network, a private physical network). In these embodiments, one or more of the server 102, the client computer system 104, the aggregator computer system 106, and the carrier computer system 110, are coupled to each other via the private network.

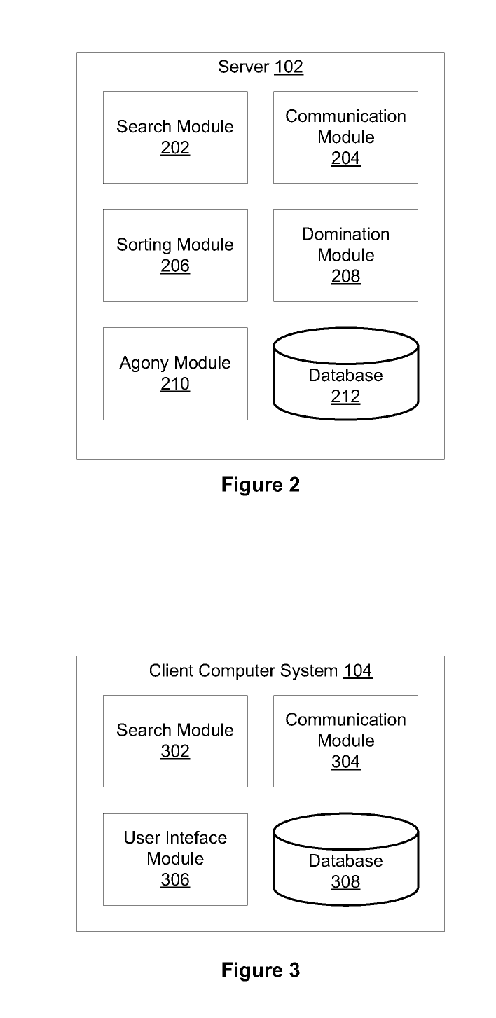

In some embodiments, the server 102 is configured to execute search queries to identify trip itineraries that satisfy search parameters received from a traveler using the client computer system 104. FIG. 2 is a block diagram illustrating the server 102, according to some embodiments. The server 102 includes a search module 202, a communication module 204, a sorting module 206, a domination module 208, an agony module 210, and a database 212. The search module 202 is configured to execute search queries to identify trip itineraries that satisfy search parameters received from the traveler using the client computer system 104. The communication module 204 is configured to receive data and/or commands (e.g., trip itineraries from the carrier computer system 110 and/or the aggregator computer system 106, search queries from the client computer system 104) via network 120 and to transmit data (e.g., trip itineraries to the client computer system 104) via network 120. The sorting module 206 is configured to generate presorted lists of trip itineraries based on predetermined criteria (e.g., by price, by date/time, by agony score). The benefit of generating the presorted lists of trip itineraries is that the client computer system 104 does not need to perform these computations, therefore freeing up computational resources on the client computer system 104. The domination module 208 is configured to determine the trip itineraries that are substantially similar to other trip itineraries and as a result are to be grouped together. For example, the substantially similar trip itineraries may be trip itineraries that have the same departure point (e.g., departure airport), the same arrival point (e.g., arrival airport), similar departure time, and similar arrival time. Typically, the substantially similar trip itineraries include trip itineraries that are deemed better than others as determined by the characteristics of the trip itineraries (e.g., the departure point, the arrival point, the departure time, the arrival time, price). The domination module 208 is described in more detail in co-pending application U.S. patent application Ser. No. ______, entitled “System and Method for Grouping Trip Itineraries”, filed ______ by inventors Steven L. Huffman and Adam J. Goldstein (Attorney Docket No. 3283.001US1). The agony module 210 is configured to generate an agony score for each trip itinerary based at least in part on the search parameters received from the traveler, traveler preferences, and/or a desirableness of the features of each trip itinerary. In some embodiments, the database 212 includes data relating to trip itineraries (e.g., received from the carrier computer system 110, the aggregator computer system 106). In some embodiments, the database 212 includes profile information for the traveler (e.g., name, credit card information, preferred carriers, preferred departure point).

In some embodiments, the server 102 periodically obtains updated data relating to trip itineraries from the carrier computer system 110 and/or the aggregator computer system 106. For example, the server 102 may obtain updated data indicating the status of trip itineraries (e.g., whether the trip itineraries are still available, the seats that are available). In these embodiments, the server 102 updates the database 212 using updated data relating to the trip itineraries.

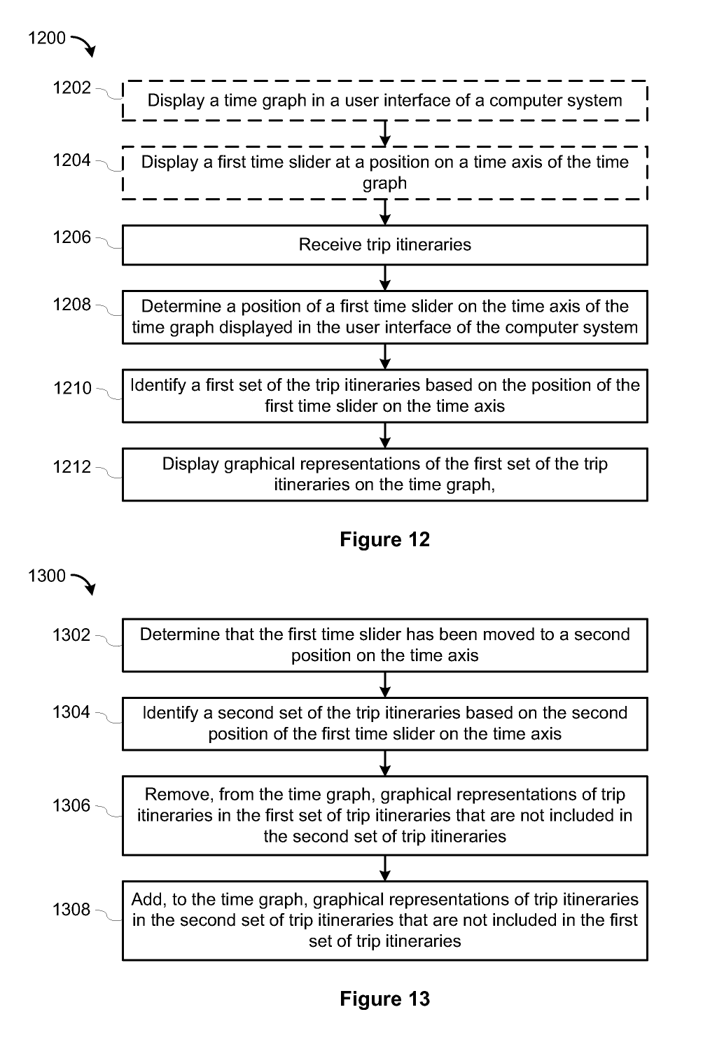

FIG. 3 is a block diagram illustrating the client computer system 104, according to some embodiments. The client computer system 104 includes a search module 302, a communication module 304, a user interface module 306, and a database 308. The search module 302 is configured to generate search queries based on search parameters provided by a traveler using the client computer system 104, receive trip itineraries from the server 102 in response to the search queries, and display the trip itineraries in a user interface of the client computer system 104. Note that the search module 302 is described in more detail below with respect to FIGS. 12-18 below. The communication module 304 is configured to transmit data and/or commands (e.g., search queries to the server 102) via network 120 and receive data and/or commands (e.g., trip itineraries from the server 102) via network 120. In some embodiments, the search module 302 includes executable code received from the server 102. For example, the executable code may be code (e.g., Java, Javascript, HTML) executable within a web browser of the client computer system 104 to implement the functionality of the search module 302 as described herein. The user interface module 306 is configured to receive data and/or commands related to the display of objects in a display device of the client computer system 104. For example, the search module 302 may send data and/or commands to user interface module 306 to display trip itineraries in the display device of the client computer system 104. In some embodiments, the database 308 includes data relating to trip itineraries (e.g., received from the server 102). In some embodiments, the database 308 includes profile information for the traveler (e.g., name, credit card information, preferred carriers, preferred departure point).

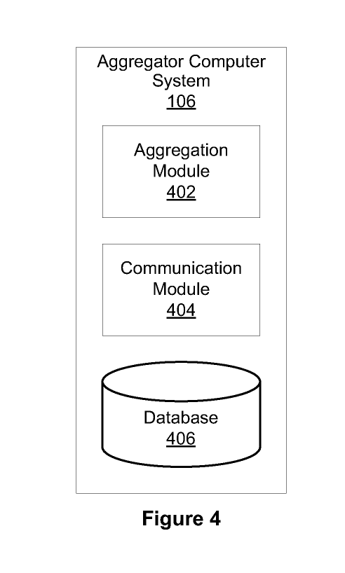

FIG. 4 is a block diagram illustrating the aggregator computer system 106, according to some embodiments. The aggregator computer system 106 includes an aggregation module 402, a communication module 404, and a database 406. The aggregation module 402 is configured to obtain trip itineraries from the carrier computer system 110. In some embodiments, the aggregation module 402 periodically obtains the trip itineraries from the carrier computer system 110. In some embodiments, the aggregation module 402 obtains the trip itineraries from the carrier computer system 110 in response to a request by the server 102 to obtain trip itineraries. The communication module 404 is configured to transmit data and/or commands (e.g., trip itineraries to the server 102) via network 120 and receive data and/or commands (e.g., trip itineraries from the carrier computer system 110) via network 120. The database 406 includes data relating to trip itineraries obtained from the carrier computer system 110.

Returning to FIG. 1, the carrier computer system 110 is configured to respond to requests from the server 102 and/or the aggregator computer system 106 for data relating to trip itineraries. In some embodiments, the trip itineraries are stored in database 111.

Note that the databases 111, 212, 308, and 406 may include any type of system for storing data in non-volatile storage. This includes, but is not limited to, systems based upon magnetic, optical, and magneto-optical storage devices, as well as storage devices based on flash memory and/or battery-backed up memory. In some embodiments, the databases 111, 212, 308, and 406 are distributed database (e.g., geographically distributed and/or distributed within a data center). In some embodiments, the databases 111, 212, 308, and 406 are relational databases. In some embodiments, the databases 111, 212, 308, and 406 are key-value stores.

The following discussion illustrates a typical process involving the networked system 100. A traveler using the client computer system 104 submits a search query including search parameters for trip itineraries to the server 102. In some embodiments, the search parameters include one or more of a departure point (e.g., departure city, departure airport, departure station), an arrival point (e.g., arrival city, arrival airport, arrival station), a departure date (or date range), a departure time (or time range), an arrival date (or date range), an arrival time (or time range), a cabin preference, a number of passengers, and preferred carriers. Note that some of the search parameters may be optional. For example, a departure point and an arrival point may be required, but the departure date, the departure time, the arrival date, the arrival time, the cabin preference, and the preferred carriers may be optional search parameters.

The server 102 then executes the search query to identify trip itineraries that satisfy the search parameters received from the client computer system 104. The server 102 may query the database 212 of the server 102 to identify trip itineraries stored in the database 212 that satisfy the search parameters. Alternatively or additionally, the server 102 may query the carrier computer system 110 and/or the aggregator computer system 106 to identify trip itineraries that satisfy the search parameters. The server 102 then transmits the identified trip itineraries to the client computer system 104.

The client computer system 104 then displays the received trip itineraries in a user interface (e.g., a web browser) on the display device of the client computer system 104. In some embodiments, the client computer system 104 displays the trip itineraries on a time graph in the user interface. In some embodiments, the time graph includes at least one time slider configured to be moved across a time axis of the time graph to filter out trip itineraries. These embodiments are described in more detail below with respect to FIGS. 12-18.

### Data Structures

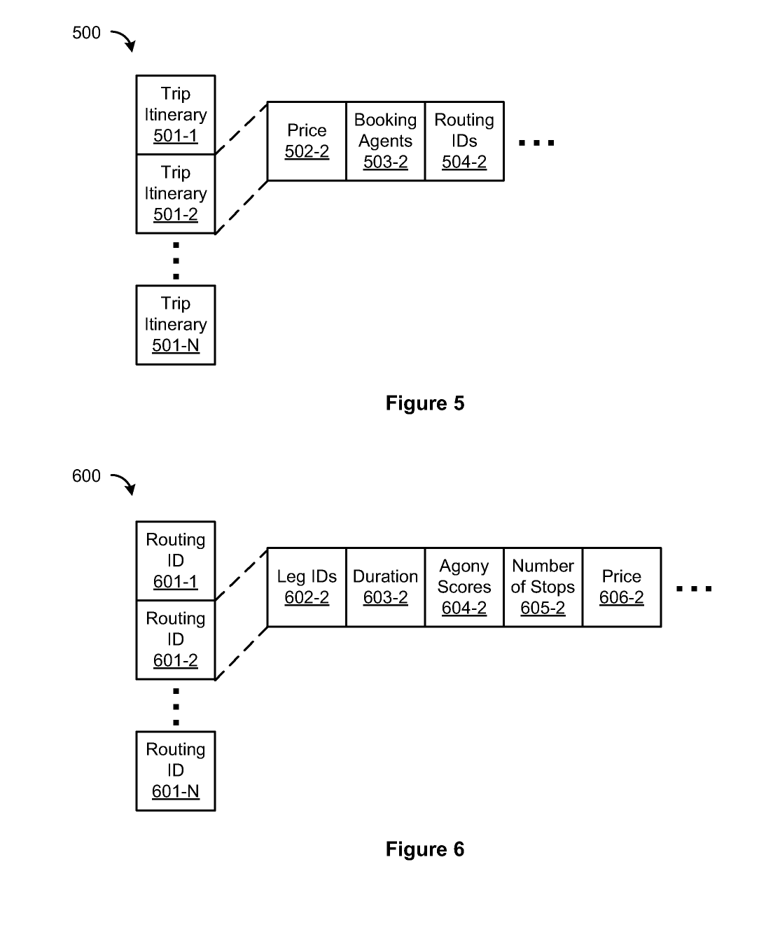

The embodiments described herein use various data structures, which are described in more detail below with respect to FIGS. 5-11.

FIG. 5 is a block diagram 500 illustrating a server-side trip itinerary data structure, according to some embodiments. The server-side trip itinerary data structure may be used by the server 102 to store trip itineraries received from the carrier computer system 110 and/or the aggregator computer system 106. Each trip itinerary 501 is associated with one or more prices 502 of the trip itinerary, one or more booking agents 503 (e.g., an online travel agent, an airline website) that are usable to book the trip itinerary, and routing IDs 504 corresponding to the routings associated with the trip itineraries. As discussed above, a routing is a collection of legs of a trip itinerary (e.g., leg 1 is SFO to PHX, leg 2 is PHX to JFK). These legs may be part of a multi-leg trip between a departure point and an arrival point and/or may be part of a round-trip itinerary. For an exemplary trip itinerary, the prices 502 may be $500 and $504 corresponding to an online travel agent and an airline website (e.g., the one or more booking agents 503), and the routing IDs 504 may include a first routing ID that includes legs from SFO to PHX and PHX to JFK, and a second routing ID that includes a leg from JFK to SFO.

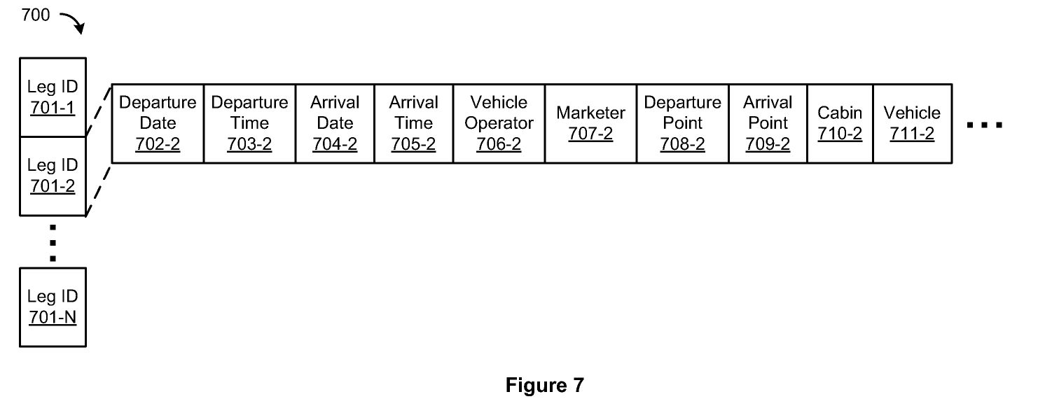

FIG. 6 is a block diagram 600 illustrating a server-side routing data structure, according to some embodiments. The server-side routing data structure is a data structure that the server 102 uses to store data relating to routings for the trip itineraries. The server-side routing data structure may be used by the server 102 to store routings received from the carrier computer system 110 and/or the aggregator computer system 106. Each routing is identified by a routing ID 601 that is associated with one or more leg IDs 602, a duration 603 of the routing (e.g., hours from the beginning to the end of the routing), agony scores 604, a number of stops 605 (e.g., layovers), and a price 606 of the routing. The one or more leg IDs 602 correspond to one or more legs of the routing, which are described in more detail below with respect to FIG. 7. The agony scores 604 indicate the extent to which the routing is desirable or not desirable. For example, a routing with a high agony score may indicate that the routing has undesirable features (e.g., likelihood of delays, has multiple stops, is expensive). In some embodiments, the agony scores 604 are based on a price of the routing, a number of stops for the routing, a duration of the routing, arrival and departure points of the routing, and a price of the routing. In some embodiments, the agony scores 604 for a routing include multiple scores. For example, the agony scores 604 for a routing may include an agony score for a typical traveler and an agony score for a traveler based on a profile of a traveler performing the search query. The agony scores 604 may also indicate the extent to which a trip itinerary is desirable or not desirable. Since a trip itinerary may include one or more routings, the trip itinerary may include a desirable routing and an undesirable routing. Thus, it may be useful to generate an agony score for the trip itinerary so that the trip itinerary is indicated to have undesirable features.

FIG. 7 is a block diagram 700 illustrating a server-side leg data structure, according to some embodiments. The server-side leg data structure is a data structure that the server 102 may use to store data relating to legs of routings received from the carrier computer system 110 and/or the aggregator computer system 106. Each leg is identified by a leg ID 701 that is associated with a departure date 702, a departure time 703, an arrival date 704, an arrival time 705, a vehicle operator 706, a marketer 707, a departure point 708 (e.g., an airport, a bus stop, a train station), an arrival point 709 (e.g., an airport, a bus stop, a train station), a cabin 710 (e.g., a cabin class), and a vehicle 711 (e.g., the vehicle type, the vehicle model). Note that the vehicle operator 706 is an entity (e.g., an airline) that operates the vehicle 711 and the marketer 707 is the entity (e.g., the airline, an airline alliance partner) that is marketing the leg (e.g., the flight). The marketer 707 and the vehicle operator 706 may be the same entity (e.g., the same airline).

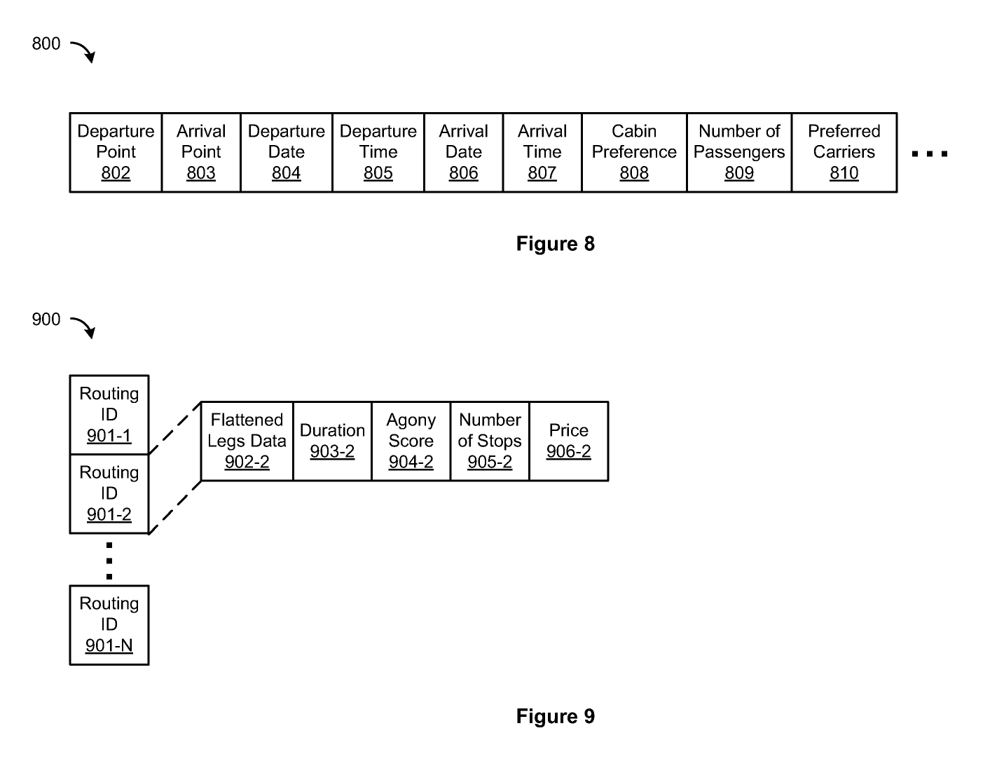

FIG. 8 is a block diagram 800 illustrating a search data structure, according to some embodiments. The search data structure is a data structure that the client computer system 104 may send to the server 102 when the client computer system 104 submits a search query to the server 102. The search data structure includes a departure point 802, an arrival point 803, and a departure date 804. The search data structure may also optionally include a departure time 805, an arrival date 806, an arrival time 807, a cabin preference 808, a number of passengers 809, and preferred carriers 810. Note that travelers may specify multiple preferred carriers 810 and/or carrier alliances, or specify that the traveler has no preference for carriers. In some embodiments, one or more of the departure point 802, the departure time 805, the arrival time 807, the cabin preference 808, the number of passengers 809, and the preferred carriers 810 are obtained from a profile for the traveler. In some embodiments, the profile of the traveler is stored on the server 102.

FIG. 9 is a block diagram 900 illustrating a client-side routing data structure, according to some embodiments. The client-side routing data structure is a data structure that is received from the server 102 and that includes a list of routings that satisfy the search query submitted by the client computer system 104. Each routing is identified by a routing ID 901 that is associated with flattened legs data 902, a duration 903, an agony score 904, a number of stops 905, and a price 906. Note that the flattened legs data 902 is the legs data from the legs data structure illustrated in FIG. 7 in flat form. In other words, the relational nature of the routings data structure and the legs data structure is removed and the data from the legs data structure is included directly in the client-side routings data structure illustrated in FIG. 9. As discussed above, the agony score 904 may include multiple agony scores (e.g., an agony score for a typical traveler, an agony score for the traveler that performed the search query).

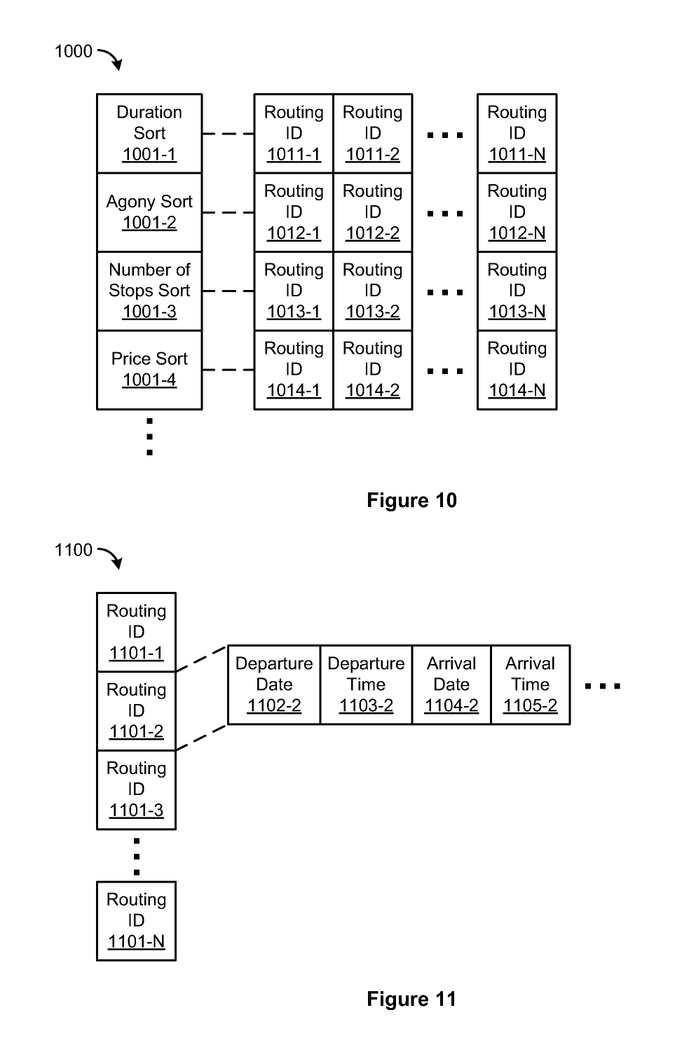

FIG. 10 is a block diagram 1000 illustrating a client-side trip itinerary data structure, according to some embodiments. The client-side trip itinerary data structure includes multiple sorts. For example, the client-side trip itinerary data structure includes a duration sort 1001-1 in which the routings (e.g., routing IDs 1011) are sorted by duration (e.g., flight duration, layover duration), an agony sort 1001-2 in which the routings (e.g., routing IDs 1012) are sorted by an agony score, a number of stops sort 1001-3 in which the routings (e.g., routing IDs 1013) are sorted by the number of stops, and a price sort 1001-4 in which the routings (e.g., routing IDs 1014) are sorted by price. In some embodiments, the server 102 generates the client-side trip itinerary data structure and sorts the routings based on sorting criteria (e.g., duration, agony score, number of stops, price). In some embodiments, the client computer system 104 receives unsorted routing data from the server 102 and sorts the routings based on the sorting criteria.

FIG. 11 is a block diagram 1100 illustrating a client-side routing time data structure, according to some embodiments. Each routing is identified by a routing ID 1101 that is associated with a departure date 1102, a departure time 1103, an arrival date 1104, and an arrival time 1105. The client-side routing time data structure may be used by the client computer system 104 to identify dates and/or times associated with routings.

### Filtering Trip Itineraries

As discussed above, a trip itinerary includes one or more routes. For example, a trip itinerary may include a first route from point A to point B and a second route from point B to point A. However, the term “trip itinerary” may also be used to refer to a single route. For example, the first route may be one trip itinerary and the second route may be another trip itinerary. In other words, the term “trip itinerary” refers generally to any route between a starting point and an ending point of a trip.

For the sake of clarity, the following discussion refers to the search module 302 of the client computer system 104 displaying various objects in the user interface of a display device for the client computer system 104. However, it should be understood that the search module 302 may send data and/or commands related to the display of objects to the user interface module 306 of the client computer system 104. The user interface module 306 may then generate and display the corresponding objects in the display device of the client computer system 104.

Moreover, although the following discussion refers to the search module 302 of the client computer system 104 performing particular operations, it should be understood that the server 102 may itself perform the operations discussed below and/or cause the computer system 104 to perform the operations discussed below. For example, the client computer system 104 may transmit (e.g., periodically transmit) data relating to the state of the user interface for the client computer system 104 (e.g., cursor position, locations of objects in the user interface) to the server 102. The server 102 may then use this data to perform the operations discussed below. Alternatively or additionally, upon receiving the data, the server 102 may instruct (or cause) the client computer system 104 to perform the operations discussed below (e.g., in operation 1212 of FIG. 12, the server 102 may instruct or cause the client computer system 104 to display graphical representations of the first set of the trip itineraries on the time graph).

Furthermore, as discussed above with respect to FIG. 3, the search module 302 may include executable code received from the server 102. In other words, the server 102 may transmit the code that implements the search module 302 to the client computer system 104.

When a traveler uses the client computer system 104 to visit a travel website hosted by the server 102, the traveler may be presented with a user interface that allows the traveler to submit a search query to the server 102 to identify trip itineraries that satisfy a search query. FIGS. 12-18 illustrate various operations that the client computer system 104 performs in order to display the trip itineraries to the traveler in an intuitive manner.

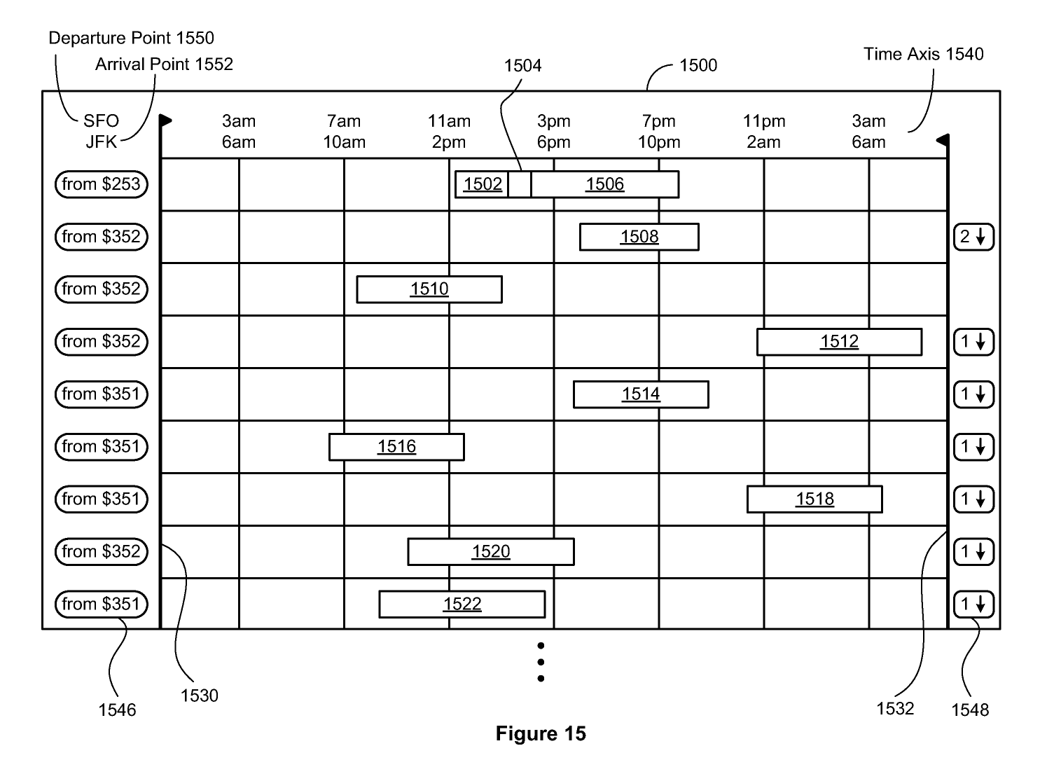

FIG. 12 is a flowchart of a method 1200 for filtering trip itineraries, according to some embodiments. To clarify the method 1200, reference is made to FIG. 15, which is a screenshot of an exemplary user interface 1500 for filtering trip itineraries, according to some embodiments. The search module 302 displays (1202) a time graph in a user interface of the client computer system 104 (e.g., a browser window displayed on the display device of the client computer system 104). An exemplary time graph is illustrated in FIG. 15. The time graph includes a time axis 1540, which may include times, dates, days of week, and the like. In FIG. 15, the time axis 1540 is displayed on the horizontal axis of the time graph; however, the time axis 1540 may be displayed on the vertical axis of the time graph. In some embodiments, the time axis 1540 includes dates and/or times corresponding to the time zones of a departure point 1550 (e.g., a departure airport) and an arrival point 1552 (e.g., arrival airport). For example, the departure point 1550 may be SFO and the arrival point 1552 may be JFK. Accordingly, the time axis 1540 may include dates and/or times with respect to the Pacific Time Zone in a first row of the time axis 1540 and dates and/or times with respect to Eastern Time Zone in a second row of the time axis 1540.

The search module 302 then displays (1204) a first time slider at a position on the time axis of the time graph. As illustrated in FIG. 15, one or more time sliders may be displayed on the time graph. For example, the time graph may include a departure time slider 1530 configured to filter out trip itineraries that depart before the time indicated by the departure time slider 1530 (e.g., trip itineraries whose departure times are to the left of the departure time slider 1530). Alternatively or additionally, the time graph may include an arrival time slider 1532 configured to filter out trip itineraries that arrive after the time indicated by the arrival time slider 1532 (e.g., trip itineraries whose arrival times are to the right of the arrival time slider 1532). In some embodiments, the departure time slider 1530 and/or the arrival time slider 1532 include a visual indicator (e.g., an arrow at the top of the departure time slider 1530 and/or the arrival time slider 1532) that indicates the time zone for which the time slider operates. For example, in FIG. 15, the departure time slider 1530 indicates that the time zone for the departure time slider 1530 corresponds to the time zone for SFO (e.g., Pacific Time Zone). Similarly, the arrival time slider 1532 indicates that the time zone for the arrival time slider 1532 corresponds to the time zone for JFK (e.g., Eastern Time Zone).

The search module 302 receives (1206) trip itineraries from the server 102. Note that the trip itineraries may be received in response to a search query submitted by the traveler using the client computer system 104.

The search module 302 determines (1208) a position of the first time slider on the time axis 1540 of the time graph displayed in the user interface of the client computer system 104. For example, the first time slider may be either of the departure time slider 1530 or the arrival time slider 1532. The position of the first time slider corresponds to a time on the time axis 1540. In some embodiments, the first time slider is configured to be moved across the time axis 1540 of the time graph.

The search module 302 identifies (1210) a first set of the trip itineraries based on the position of the first time slider on the time axis 1540. In some embodiments, when the first time slider is the departure time slider 1530, the search module 302 identifies the first set of the trip itineraries based on the position of the first time slider on the time axis by identifying a set of trip itineraries that have a departure time after a time corresponding to the position of the first time slider on the time axis 1540. In some embodiments, when the first time slider is the departure time slider 1530, the search module 302 identifies the first set of the trip itineraries based on the position of the first time slider on the time axis by identifying a set of trip itineraries that have a departure time before a time corresponding to the position of the first time slider on the time axis 1540. In some embodiments, when the first time slider is the arrival time slider 1532, the search module 302 identifies the first set of the trip itineraries based on the position of the first time slider on the time axis by identifying a set of trip itineraries that have an arrival time before a time corresponding to the position of the first time slider on the time axis 1540. In some embodiments, when the first time slider is the arrival time slider 1532, the search module 302 identifies the first set of the trip itineraries based on the position of the first time slider on the time axis by identifying a set of trip itineraries that have an arrival time after a time corresponding to the position of the first time slider on the time axis 1540.

The search module 302 displays (1212) graphical representations of the first set of the trip itineraries on the time graph. In some embodiments, a graphical representation of a trip itinerary indicates a departure time and duration of the trip itinerary. As illustrated in FIG. 15, trip itineraries may be represented using time bars 1502, 1504, 1506, 1508, 1510, 1512, 1514, 1516, 1518, 1520, and 1522. As discussed above, a trip itinerary may include multiple routings and a routing may include multiple legs. In FIG. 15, one routing of a trip itinerary is displayed (e.g., SFO to JFK) where each of these routings include at least one leg of the trip itinerary. For example, a first trip itinerary includes a routing that has legs represented by the time bar 1502 (e.g., corresponding to a leg from SFO to PHX) and the time bar 1506 (e.g., corresponding to a leg from PHX to JFK). The time bar 1504 may represent the amount of time spent at a layover (e.g., at PHX). Similarly, a second trip itinerary includes a routing that has a leg represented by the time bar 1508 (e.g., corresponding to a leg from SFO to JFK). This technique for representing trip itineraries is beneficial because a traveler can easily analyze the search results to identify desirable trip itineraries.

FIG. 15 also includes a price 1546 for each of the trip itineraries. In some embodiments, when a group of trip itineraries have similar qualities (e.g., similar pricing, similar departure times and arrival times), a dominating trip itinerary is selected from the group of trip itineraries and displayed on the time graph while the other trip itineraries in the group are not displayed. Note that the other trip itineraries in the group that are not displayed are referred to as “dominated trip itineraries”. The dominating trip itinerary is the trip itinerary that is deemed to be the best trip itinerary of its group. The best trip itinerary may be determined based on the price, departure times, arrival times, layover duration, and the like. Furthermore, a traveler may select factors that are more important than others. For example, a traveler may indicate that price should be given higher weight than departure times. To indicate the existence of the dominated trip itineraries, a domination indicator 1548 may be displayed to indicate the existence of the other trip itineraries that are similar to the dominating trip itinerary. As illustrated in FIG. 15, a number of dominated trip itineraries may be included in the domination indicator 1548.

Note that operations 1202 and 1204 are optional. For example, in cases where the traveler has already submitted a previous search query to identify trip itineraries, the time graph and the first time slider may already be displayed in the user interface of the client computer system 104. In these cases, the traveler may use the client computer system 104 to submit new search queries to the server 102 and/or filter out trip itineraries using the departure time slider 1530 and/or the arrival time slider 1532. In response to the search queries, the server 102 transmits trip itineraries that satisfy the search queries to the client computer system 104. The search module 302 of the client computer system 104 may then display the trip itineraries in the time graph that is already displayed in the user interface of the client computer system 104.

Also note that some operations discussed with respect to FIG. 12 may be performed in any order. For example operations 1202, 1204, 1206, and 1208 may be performed in any order.

After the initial display of the trip itineraries illustrated in FIG. 15, the traveler may desire to further filter out trip itineraries by specifying a departure time limit and/or an arrival time limit. FIGS. 13-14 and 16-18 illustrate the process of filtering out trip itineraries.

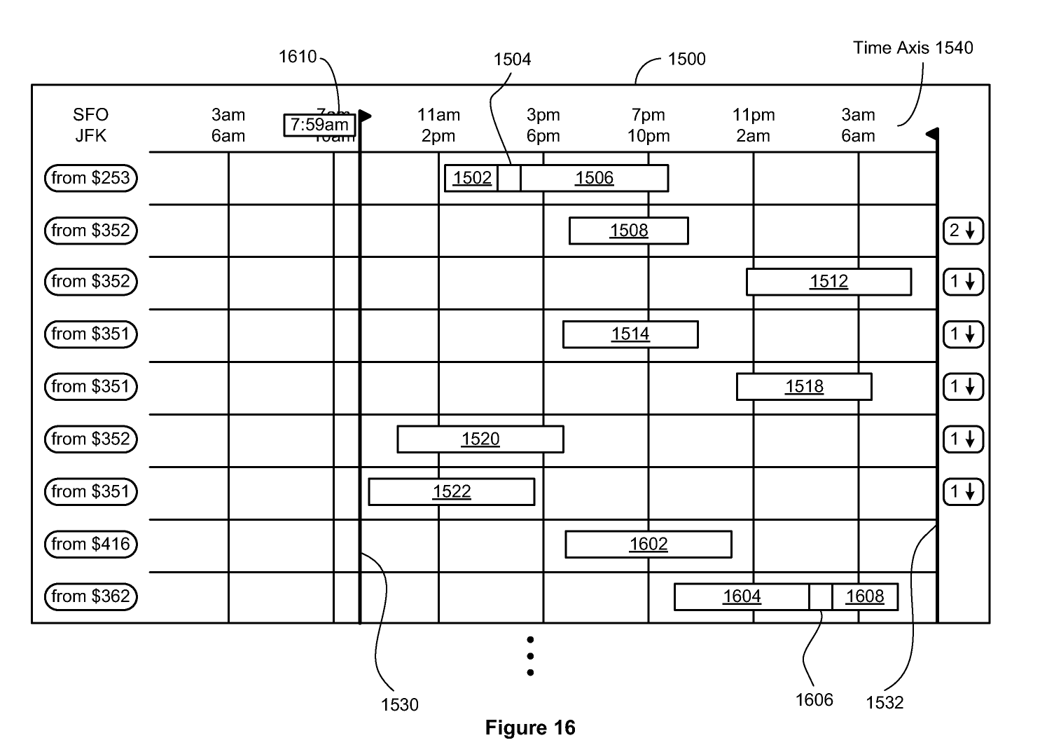

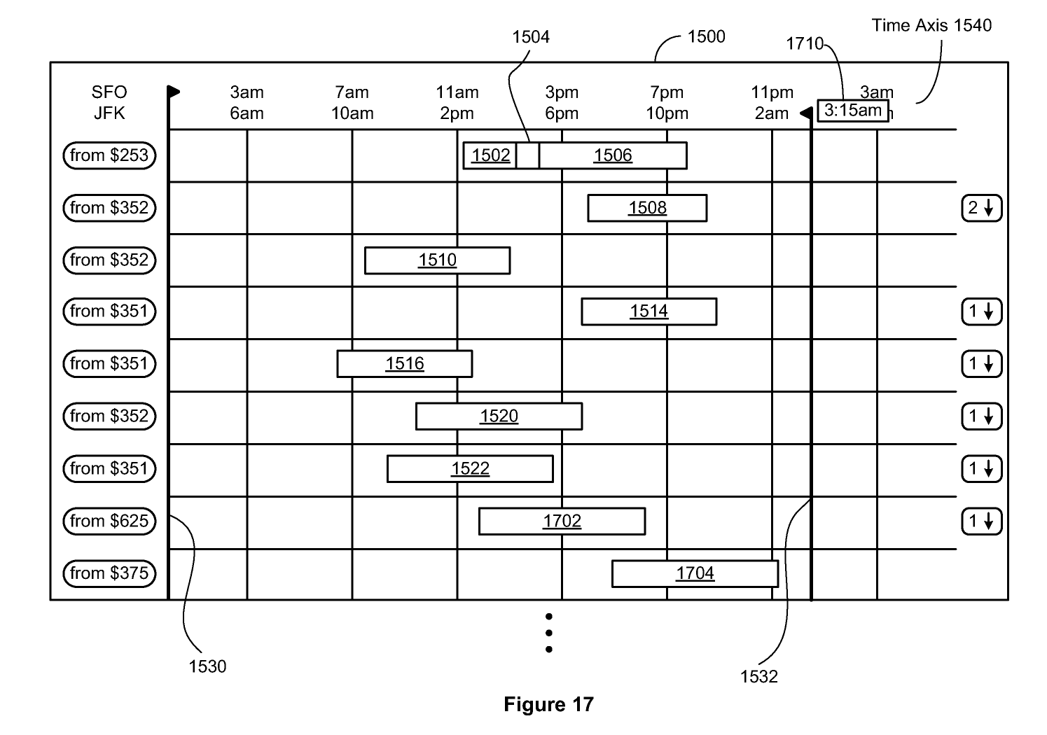

FIG. 13 is a flowchart of a method 1300 for updating displayed trip itineraries, according to some embodiments. To clarify the method 1300, reference is made to FIGS. 16 and 17.

The search module 302 determines (1302) that the first time slider has been moved to a second position on the time axis. For example, FIG. 16 illustrates that the departure time slider 1530 has been moved to the right and FIG. 17 illustrates that the arrival time slider 1532 has been moved to the left. In some embodiments, a time corresponding to the position of the slider in the time graph is displayed. For example, in FIG. 16, a time 1610 is displayed on the time graph adjacent to the departure time slider 1530 and in FIG. 17, a time 1710 is displayed on the time graph adjacent to the arrival time slider 1532.

The search module 302 identifies (1304) a second set of the trip itineraries based on the second position of the first time slider on the time axis. For example, in FIG. 16, the search module 302 may identify that the second set of trip itineraries are the trip itineraries that correspond to time bars 1502, 1504, 1506, 1508, 1512, 1514, 1518, 1520, 1522, 1602, 1604, 1606, and 1608. Similarly, in FIG. 17, the search module 302 may identify that the second set of trip itineraries are the trip itineraries that correspond to time bars 1502, 1504, 1506, 1508, 1510, 1514, 1516, 1520, 1522, 1702, and 1704.

The search module 302 removes (1306), from the time graph, graphical representations of trip itineraries in the first set of trip itineraries that are not included in the second set of trip itineraries and adds (1308), to the time graph, graphical representations of trip itineraries in the second set of trip itineraries that are not included in the first set of trip itineraries. In FIG. 16, the search module 302 removes the trip itineraries that correspond to time bars 1510 and 1516, and adds the trip itineraries that correspond to time bars 1602, 1604, 1606, and 1608. In FIG. 17, the search module removes the trip itineraries that correspond to time bars 1512 and 1518, and adds the trip itineraries that correspond to time bars 1702 and 1704.

Note that although the search module 302 added the trip itineraries that correspond to time bars 1602, 1604, and 1608 in FIG. 16 and added the trip itineraries that correspond to time bars 1702 and 1704, these trip itineraries were originally included in the trip itineraries received from the server 102 as discussed with respect to operation 1206 in FIG. 12. The operations described in FIGS. 13, 16, and 17 are performed on existing trip itineraries to filter out trip itineraries based on the departure time slider 1530 or the arrival time slider 1532. For example, these trip itineraries may have been located outside of the viewable area of the user interface 1500. In other words, these trip itineraries may have been located in a scrollable area of the user interface 1500, but were not originally displayed in FIGS. 15. Alternatively, or additionally, these trip itineraries may have been dominated trip itineraries that were represented by a dominating trip itinerary. When the departure time slider 1530 and the arrival time slider 1532 are moved to the second position, the search module 302 may have recalculated the grouping of the dominated itineraries. For example, the dominating trip itinerary that was displayed may have been filtered out by the time sliders, leaving these trip itineraries.

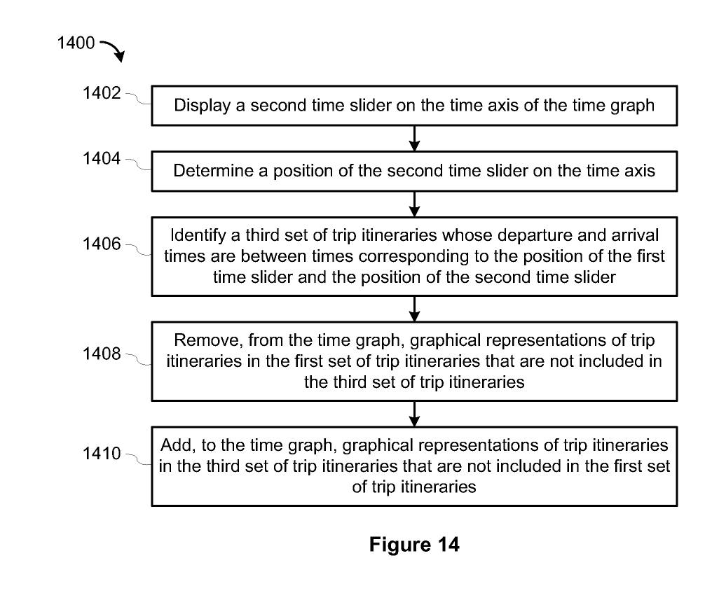

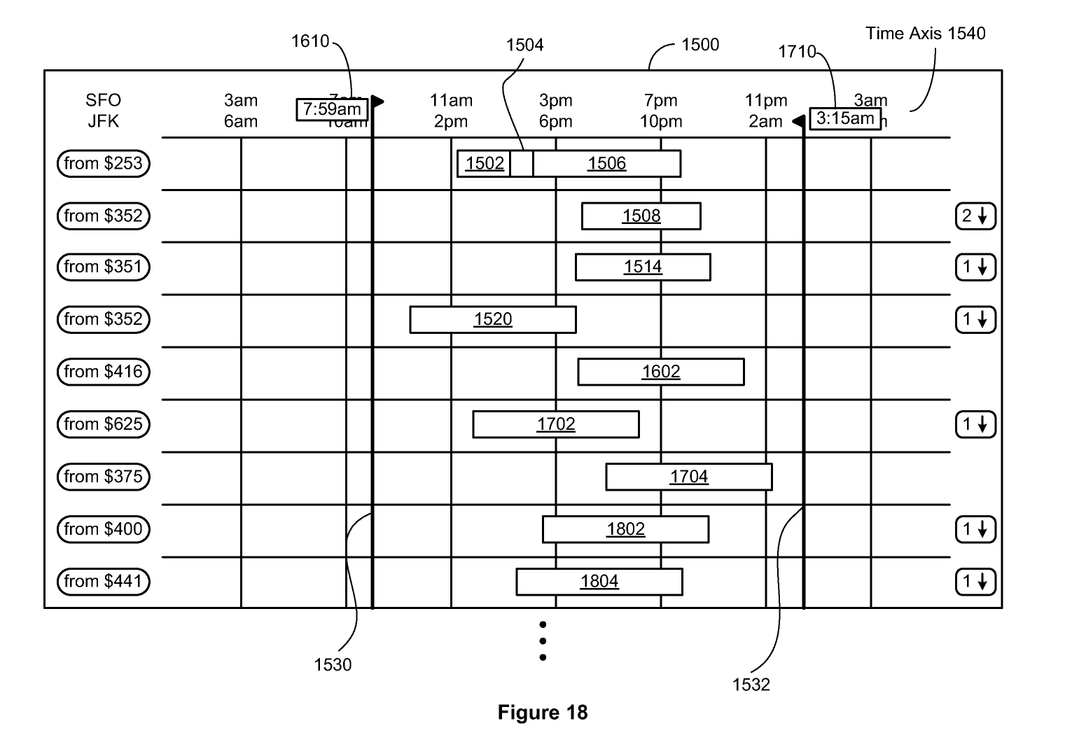

FIG. 14 is a flowchart of method 1400 for using two time sliders to update displayed trip itineraries, according to some embodiments. To clarify the method 1400, reference is made to FIG. 18.

The search module 302 displays (1402) a second time slider on the time axis 1540 of the time graph, wherein the second time slider is configured to be moved across the time axis 1540 of the time graph. For example, if the departure time slider 1530 is the first time slider, the second time slider may be the arrival time slider 1532, and vice versa.

The search module 302 determines (1404) a position of the second time slider on the time axis 1540.

The search module 302 identifies (1406) a third set of trip itineraries whose departure and arrival times are between times corresponding to the position of the first time slider and the position of the second time slider (e.g., between the departure time slider 1530 and the arrival time slider 1532). In FIG. 18, the search module 302 may identify that the third set of trip itineraries are the trip itineraries that correspond to time bars 1502, 1504, 1506, 1508, 1514, 1520, 1602, 1702, 1704, 1802, and 1804.

The search module 302 then removes (1408), from the time graph, graphical representations of trip itineraries in the first set of trip itineraries (e.g., the trip itineraries identified in operation 1210 and illustrated in FIG. 15) that are not included in the third set of trip itineraries and adds (1410), to the time graph, graphical representations of trip itineraries in the third set of trip itineraries that are not included in the first set of trip itineraries. In FIG. 18, the search module 302 removes the trip itineraries that correspond to time bars 1510, 1512, 1516, 1518, and 1522. The search module 302 adds the trip itineraries that correspond to time bars 1602, 1702, 1704, 1802, and 1804.

Displaying trip itineraries in a manner described with respect to FIGS. 12-18 is beneficial because a traveler viewing the trip itineraries can easily visualize the duration and scheduling of trip itineraries relative to each other. Furthermore, when using the departure time slider 1530 and/or the arrival time slider 1532 to filter out trip itineraries, the traveler has intuition as to which trip itineraries may be filtered out.

### Exemplary Machine

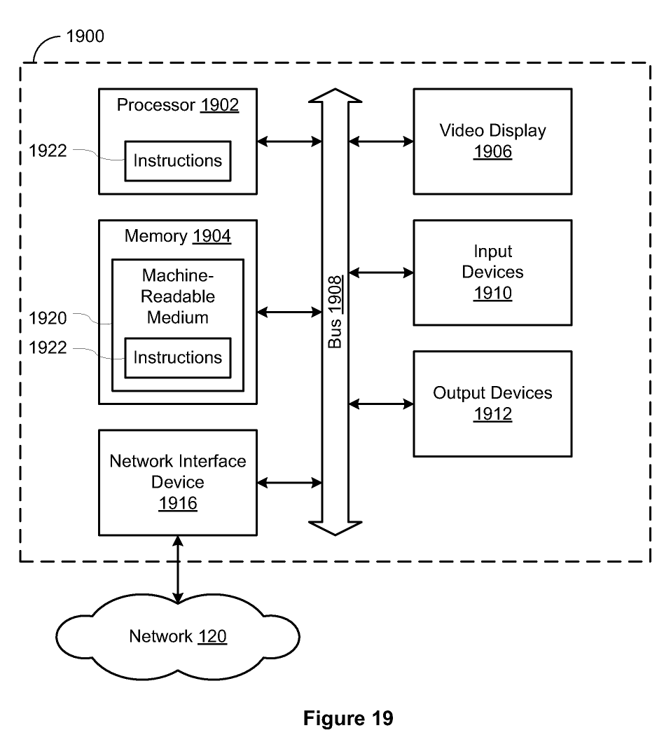

FIG. 19 depicts a block diagram of a machine in the example form of a computer system 1900 within which may be executed a set of instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment or as a peer machine in a peer-to-peer (or distributed) network environment. The computer system 1900 may include, but is not limited to, a desktop computer system, a laptop computer system, a server, a mobile phone, a smart phone, a personal digital assistant (PDA), a gaming console, a portable gaming console, a set top box, a camera, a printer, a television set, or any other electronic device.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the computer system 1900 includes a processor 1902 (e.g., a central processing unit (CPU), a graphics processing unit (GPU) or both), and memory 1904, which communicate with each other via bus 1908. Memory 1904 includes volatile memory devices (e.g., DRAM, SRAM, DDR RAM, or other volatile solid state memory devices), non-volatile memory devices (e.g., magnetic disk memory devices, optical disk memory devices, flash memory devices, tape drives, or other non-volatile solid state memory devices), or a combination thereof. Memory 1904 may optionally include one or more storage devices remotely located from the computer system 1900. The computer system 1900 may further include a video display unit 1906 (e.g., a plasma display, a liquid crystal display (LCD) or a cathode ray tube (CRT)). The computer system 1900 also includes input devices 1910 (e.g., keyboard, mouse, trackball, touchscreen display), output devices 1912 (e.g., speakers), and a network interface device 1916. The aforementioned components of the computer system 1900 may be located within a single housing or case (e.g., as depicted by the dashed lines in FIG. 19). Alternatively, a subset of the components may be located outside of the housing. For example, the video display unit 1906, the input devices 1910, and the output devices 1912 may exist outside of the housing, but be coupled to the bus 1908 via external ports or connectors accessible on the outside of the housing.

Memory 1904 includes a machine-readable medium 1920 on which is stored one or more sets of data structures and instructions 1922 (e.g., software) embodying or utilized by any one or more of the methodologies or functions described herein. The one or more sets of data structures may store data. Note that a machine-readable medium refers to a storage medium that is readable by a machine (e.g., a computer-readable storage medium). The data structures and instructions 1922 may also reside, completely or at least partially, within memory 1904 and/or within the processor 1902 during execution thereof by computer system 1900, with memory 1904 and processor 1902 also constituting machine-readable, tangible media.

The data structures and instructions 1922 may further be transmitted or received over network 120 via network interface device 1916 utilizing any one of a number of well-known transfer protocols (e.g., HyperText Transfer Protocol (HTTP)). Network 120 can generally include any type of wired or wireless communication channel capable of coupling together computing nodes (e.g., the computer system 1900). This includes, but is not limited to, a local area network (LAN), a wide area network (WAN), or a combination of networks. In some embodiments, network 120 includes the Internet.

Certain embodiments are described herein as including logic or a number of components, modules, or mechanisms. Modules may constitute either software modules (e.g., code and/or instructions embodied on a machine-readable medium or in a transmission signal) or hardware modules. A hardware module is a tangible unit capable of performing certain operations and may be configured or arranged in a certain manner. In example embodiments, one or more computer systems (e.g., the computer system 1900) or one or more hardware modules of a computer system (e.g., a processor 1902 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a processor 1902 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a processor 1902 configured using software, the processor 1902 may be configured as respective different hardware modules at different times. Software may accordingly configure a processor 1902, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors 1902 that are temporarily configured (e.g., by software, code, and/or instructions stored in a machine-readable medium) or permanently configured to perform the relevant operations. Whether temporarily or permanently configured, such processors 1902 may constitute processor-implemented (or computer-implemented) modules that operate to perform one or more operations or functions. The modules referred to herein may, in some example embodiments, comprise processor-implemented (or computer-implemented) modules.

Moreover, the methods described herein may be at least partially processor-implemented (or computer-implemented) and/or processor-executable (or computer-executable). For example, at least some of the operations of a method may be performed by one or more processors 1902 or processor-implemented (or computer-implemented) modules. Similarly, at least some of the operations of a method may be governed by instructions that are stored in a computer-readable storage medium and executed by one or more processors 1902 or processor-implemented (or computer-implemented) modules. The performance of certain of the operations may be distributed among the one or more processors 1902, not only residing within a single machine, but deployed across a number of machines. In some example embodiments, the processors 1902 may be located in a single location (e.g., within a home environment, an office environment or as a server farm), while in other embodiments the processors 1902 may be distributed across a number of locations.

While the embodiment(s) is (are) described with reference to various implementations and exploitations, it will be understood that these embodiments are illustrative and that the scope of the embodiment(s) is not limited to them. In general, the embodiments described herein may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and its practical applications, to thereby enable others skilled in the art to best utilize the embodiments and various embodiments with various modifications as are suited to the particular use contemplated.

What is claimed is:

1. A computer-implemented method for filtering trip itineraries, the method comprising:
receiving trip itineraries;
using at least one processor, determining a position of a first time slider on a time axis of a time graph displayed in a user interface of a computer system, the first time slider configured to be moved across the time axis of the time graph;
identifying a first set of the trip itineraries based on the position of the first time slider on the time axis; and
displaying graphical representations of the first set of the trip itineraries on the time graph, a graphical representation of a trip itinerary indicating a departure time and duration of the trip itinerary.

2. The computer-implemented method of claim 1, wherein the first time slider is a departure time slider, and wherein identifying the first set of the trip itineraries based on the position of the first time slider on the time axis includes identifying a set of trip itineraries that have a departure time after a time corresponding to the position of the first time slider on the time axis.

3. The computer-implemented method of claim 1, wherein the first time slider is a departure time slider, and wherein identifying the first set of the trip itineraries based on the position of the first time slider on the time axis includes identifying a set of trip itineraries that have a departure time before a time corresponding to the position of the first time slider on the time axis.

4. The computer-implemented method of claim 1, wherein the first time slider is an arrival time slider, and wherein identifying the first set of the trip itineraries based on the position of the first time slider on the time axis includes identifying a set of trip itineraries that have an arrival time before a time corresponding to the position of the first time slider on the time axis.

5. The computer-implemented method of claim 1, wherein the first time slider is an arrival time slider, and wherein identifying the first set of the trip itineraries based on the position of the first time slider on the time axis includes identifying a set of trip itineraries that have an arrival time after a time corresponding to the position of the first time slider on the time axis.

6. The computer-implemented method of claim 1, further comprising:
determining that the first time slider has been moved to second position on the time axis;
identifying a second set of the trip itineraries based on the second position of the first time slider on the time axis;
removing, from the time graph, graphical representations of trip itineraries in the first set of trip itineraries that are not included in the second set of trip itineraries; and
adding, to the time graph, graphical representations of trip itineraries in the second set of trip itineraries that are not included in the first set of trip itineraries.

7. The computer-implemented method of claim 1, further comprising:
displaying a second time slider on the time axis of the time graph, the second time slider configured to be moved across the time axis of the time graph;
determining a position of the second time slider on the time axis;
identifying a third set of trip itineraries whose departure and arrival times are between times corresponding to the position of the first time slider and the position of the second time slider;
removing, from the time graph, graphical representations of trip itineraries in the first set of trip itineraries that are not included in the third set of trip itineraries; and
adding, to the time graph, graphical representations of trip itineraries in the third set of trip itineraries that are not included in the first set of trip itineraries.

8. The computer-implemented method of claim 7, further comprising displaying a time corresponding to the position of the second time slider.

9. The computer-implemented method of claim 1, further comprising displaying a time corresponding to the position of the first time slider.

10. The computer-implemented method of claim 1, wherein the trip itineraries are received from a server in response to a search query.

11. The computer-implemented method of claim 1, wherein prior to determining the position of the first time slider on the time axis of the time graph, the method further comprises:
displaying the time graph in the user interface of the computer system; and
displaying the first time slider at the position on the time axis of the time graph.

12. The computer-implemented method of claim 1, wherein the time axis of the time graph is a horizontal axis, and wherein the first time slider is a vertical line that is perpendicular to the time axis.

13. A system to filter trip itineraries, the system comprising:
a processor-implemented search module configured to:
receive trip itineraries;
determine a position of a first time slider on a time axis of a time graph displayed in a user interface of a computer system, the first time slider configured to be moved across the time axis of the time graph;
identify a first set of the trip itineraries based on the position of the first time slider on the time axis; and
display graphical representations of the first set of the trip itineraries on the time graph, a graphical representation of a trip itinerary indicating a departure time and duration of the trip itinerary.

14. The system of claim 13, wherein the first time slider is a departure time slider, and wherein when identifying the first set of the trip itineraries based on the position of the first time slider on the time axis, the processor-implemented search module is configured to identify a set of trip itineraries that have a departure time after a time corresponding to the position of the first time slider on the time axis.

15. The system of claim 13, wherein the first time slider is a departure time slider, and wherein when identifying the first set of the trip itineraries based on the position of the first time slider on the time axis, the processor-implemented search module is configured to identify a set of trip itineraries that have a departure time before a time corresponding to the position of the first time slider on the time axis.

16. The system of claim 13, wherein the first time slider is an arrival time slider, and wherein when identifying the first set of the trip itineraries based on the position of the first time slider on the time axis, the processor-implemented search module is configured to identify a set of trip itineraries that have an arrival time before a time corresponding to the position of the first time slider on the time axis.

17. The system of claim 13, wherein the first time slider is an arrival time slider, and wherein when identifying the first set of the trip itineraries based on the position of the first time slider on the time axis, the processor-implemented search module is configured to identify a set of trip itineraries that have an arrival time after a time corresponding to the position of the first time slider on the time axis.

18. A computer readable storage medium storing at least one program that, when executed by at least one processor, causes the at least one processor to perform operations comprising:
receiving trip itineraries;
determining a position of a first time slider on a time axis of a time graph displayed in a user interface of a computer system, the first time slider configured to be moved across the time axis of the time graph;
identifying a first set of the trip itineraries based on the position of the first time slider on the time axis; and
displaying graphical representations of the first set of the trip itineraries on the time graph, a graphical representation of a trip itinerary indicating a departure time and duration of the trip itinerary.

19. A computer-implemented method for filtering trip itineraries, the method comprising:
receiving trip itineraries;
using at least one processor, determining a position of a first time slider on a time axis of a time graph displayed in a user interface of a computer system, the first time slider being movable relative to the time axis of the time graph to select time data, and the position of the first time slider identifying the selected time data;
identifying a first set of the trip itineraries using the selected time data; and
displaying graphical representations of the first set of the trip itineraries on the time graph, a graphical representation of a trip itinerary indicating a departure time and duration of the trip itinerary.

20. The computer-implemented method of claim 19, further comprising:
determining that the first time slider has been moved to a further position on the time axis to select further time data;
identifying a second set of the trip itineraries using the selected further time data;
removing, from the time graph, graphical representations of trip itineraries in the first set of trip itineraries that are not included in the second set of trip itineraries; and
adding, to the time graph, graphical representations of trip itineraries in the second set of trip itineraries that are not included in the first set of trip itineraries.

21. The computer-implemented method of claim 19, further comprising:
displaying a second time slider on the time axis of the time graph;
determining a position of the second time slider on the time axis, the second time slider being movable relative to the time axis of the time graph to select second time data, and the position of the second time slider identifying the selected second time data;
identifying a third set of trip itineraries using the selected second time data;
removing, from the time graph, graphical representations of trip itineraries in the first set of trip itineraries that are not included in the third set of trip itineraries; and
adding, to the time graph, graphical representations of trip itineraries in the third set of trip itineraries that are not included in the first set of trip itineraries.
